(19) United States
(12) Patent Application Publication
(10) Pub. No.: US 2010/0291850 A1
(43) Pub. Date: Nov. 18, 2010

(54) Variable Volume Air-Flow Exhaust System

(76) Inventors: Mike Sabbaghian, Irvine, CA (US); Brad Cochran, Ft. Collins, CO (US); Ron Peterson, Ft. Collins, CO (US); Tom Sieber, Chula Vista, CA (US)

Correspondence Address: John Karl Buche;BUCHE & ASSOCIATES, P.C., 875 PROSPECT, SUITE 305, LA JOLLA, CA, 92037, US

(21) Appl. No.: 12/773,721

(22) Filed: May 4, 2010

Related U.S. Application Data
(60) Provisional application No. 61/175,747, filed on May 5, 2009.

(51) Int. Cl. B08B 15/02

(52) U.S. Cl. 454/61

(57) ABSTRACT

Disclosed is a smart and adaptive laboratory hood or building exhaust air system and related methods of use.

### CROSS-REFERENCE TO RELATED APPLICATIONS

This application claims the priority of U.S. Prov. Pat. App. Ser. No. 61/175,747 (filed May 5, 2009) entitled “Variable Volume Air-flow Exhaust System.”

### STATEMENT REGARDING FEDERALLY SPONSORED RESEARCH OR DEVELOPMENT

Not applicable.

### BACKGROUND OF THE INVENTION

1. Field of Invention

The present application is in the field of variable volume building exhaust systems. The present application is also in the field of smart and adaptive laboratory hood exhaust and/or environmental exhaust systems. Furthermore, the present application is in the field of retrofitting conventional constant volume or variable volume exhaust systems on buildings with improved variable volume exhaust systems.

2. Description of the Related Art

Conventional laboratory hood and/or environmental exhaust systems discharge contaminated air into the atmosphere from the rooftop of the laboratory or the associated building structure (e.g., laboratories, hospitals, universities, government facilities, semiconductor manufacturing plants, pharmaceutical manufacturing plants, chemical plants, petrochemical plants, and etcetera). Laboratory hood is defined for the purposes of this application to include, without being limited to, any or all of the following: chemical hood, snorkel, biosafety cabinet, radioactive hood, or the exhaust directly from pieces of equipment that have exhaust air that is contaminated with odors or hazardous materials. Environmental exhausts are exhausts from enclosed spaces or rooms that are contaminated with odors or hazardous materials. The exhaust air is typically regulated by Federal or State OSHA Agencies and must be discharged at a rate sufficient to maintain location specific (e.g., air intakes, operable windows, pedestrian areas, and etcetera) air-quality standards (i.e., safe air-to-hazard concentrations and odor thresholds). For any given building exhaust system, an exhaust plume height, velocity, concentration gradient, and geometric characteristics may be calculated whereby the exhaust plume is dispersed to sufficient air-quality standards prior to arriving at the specified locations. Plume height depends on, among other things, the crosswind speed, wind direction, temporary and intermittent turbulence events (e.g., approaching aircraft), and the exhaust discharge rate (usually measured in volumetric flow). The exhausts of concern may have one or more of the following constituents: toxic chemicals, hazardous bio-organisms, radioactive materials, and/or objectionable odors.

Typically, conventional exhaust systems containing toxic chemicals, hazardous bio-organisms, radioactive materials, and/or objectionable odors employ a constant volumetric discharge rate which is set according to the 100-year high cross-wind speed (or 1% wind speed (i.e., the wind speed that is exceeded no more than 1% of the time)), set for any wind direction, and set for the longest duration and highest number of external turbulence events. In other words, the exhaust flow is set for a plume height to ensure compliance with air-quality restrictions in the “worst-case” scenario (i.e., constant discharge rates are set in order to ensure appropriate plume heights and air-quality despite the highest crosswind speeds, variable wind directions, and external turbulence events number and duration).

Unpreferable effects result from the typical operation of conventional laboratory exhaust systems. Operating an exhaust systems for compliance with air-quality restrictions in the “worst-case:” excessively consumes energy and thus increases operating costs (an increase in volumetric output exhaust flow produces an approximately cubic increase in energy consumption); places excessive demands on system hardware and thus decreases the overall system and component life; produces excessive noise pollution since the system operates at higher than necessary fan rotation speed.

Additionally, a conventional exhaust system typically comprises at least one active fan, at least one standby fan, and a large bypass air damper. Variable exhaust air amounts are usually provided to the exhaust system, and the bypass damper provides ambient air to compensate for the lower volume whereby the exhaust system maintains its constant discharge flow rates and associated plume height for air-quality compliance. Continually operating a bypass air damper in conjunction with the exhaust fans contributes to the excessive energy expenditures. Also, providing a standby fan is an additional upfront cost since the fan is only used if another fan goes down.

Conventional exhaust systems are not provided with mechanisms for anticipating maintenance concerns. Accordingly, system repairs entail excessive costs since problem diagnosis is necessary before repair, whereby down-time is extended.

Accordingly, a need exists for an exhaust system capable of reducing superfluous energy expenditures and operating costs. A need also exists for an exhaust system or method of operating an exhaust system, wherein noise pollution is reduced and system life is increased. A need also exists for a system capable of anticipating maintenance concerns. Finally, a need exists for a method of retrofitting a conventional exhaust system with a variable flow system.

### SUMMARY OF THE INVENTION

Accordingly, it is an object of the present invention to provide a building exhaust system for eliminating or substantially reducing superfluous energy expenditures. As a corollary, it is also an object of the present invention to provide an air-quality compliant laboratory or building exhaust system, the operation of which produces continually customized discharge rates for the variable real-time ambient conditions (including but not limited to crosswind speed, wind direction, external turbulence event size and duration, and laboratory exhaust air volume).

Another object of the present invention is to provide a method for eliminating or substantially reducing superfluous energy expenditures during the operation of a laboratory or building exhaust system. Relatedly, it is also an object of the present invention to provide a method for dynamically adjusting the operation of a building or laboratory exhaust system whereby continually customized discharge rates for the variable real-time ambient conditions (including but not limited to crosswind speed, wind direction, external turbulence event size and duration, and laboratory exhaust air volume) are produced.

Yet another object of the present invention is to provide a laboratory or building exhaust system or method for operating an exhaust system wherein noise pollution is reduced.

Yet another object of the present invention is to provide a laboratory or building exhaust system or method for operating an exhaust system wherein system and component life is prolonged.

It is also an object of the present invention to provide a laboratory or building exhaust system or method for operating an exhaust system wherein system operation also provides a mechanism for anticipating system maintenance concerns.

It is an object of the present invention to provide a laboratory or building exhaust system or method for operating an exhaust system that does not require a standby fan or that is able to use the standby fan during normal operation to reduce energy expenditure and noise.

It is further an object of the present invention to method of retrofitting conventional laboratory hood or building exhaust systems with a variable flow exhaust system.

### BRIEF DESCRIPTION OF THE FIGURES

Other objectives of the invention will become apparent to those skilled in the art once the invention has been shown and described. The manner in which these objectives and other desirable characteristics can be obtained is explained in the following description and attached figures in which:

FIG. 1 is a preferable schematic of the exhaust system of the present application;

FIG. 2 and FIG. 3 are respectively a plan and side view of a portion of a preferable exhaust system, which figures provided context to the schematic of FIG. 1.

FIG. 4 is a preferable architectural plan of the direct digital control system of the exhaust system of the present application; and,

FIG. 5 is a preferable exhaust system fan sequence.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

In general, the exhaust system of the present invention is a smart and adaptive laboratory hood or building exhaust system (e.g., laboratories, hospitals, universities, government facilities, semiconductor manufacturing plants, pharmaceutical manufacturing plants, chemical plants, petrochemical plants, and general buildings) (hereinafter “exhaust system”). The presently disclosed exhaust system preferably comprises software driven hardware for sensing real-time internal and ambient conditions (e.g., crosswind speed, wind direction, external turbulence event size and duration, laboratory exhaust air volume, and etcetera) and for dynamically adjusting the output flow rate of the exhaust system whereby air-quality compliant exhaust is achieved (i.e., adjusting the exhaust output for minimal compliance with plume height and air-quality regulations and restrictions). Suitably, the exhaust system comprises a plurality of out-flow fans, and the aforementioned variation in exhaust output flow rate is accomplished by adjusting, as a function of the internal and ambient conditions, the individual fan exhaust output levels to between 0% and 100% of full emissive capacity. Preferable operation of the exhaust system is accomplished via operating all of the out-flow fans therein at fractional to zero capacities, however, the system may suitably operate with a downed fan by operating all operable out-flow fans at fractional to full capacities. Varying the output levels of the fans to between 0% and 100% of full emissive capacity as needed reduces energy expenditures, noise pollution, and overall wear and tear on the exhaust fans.

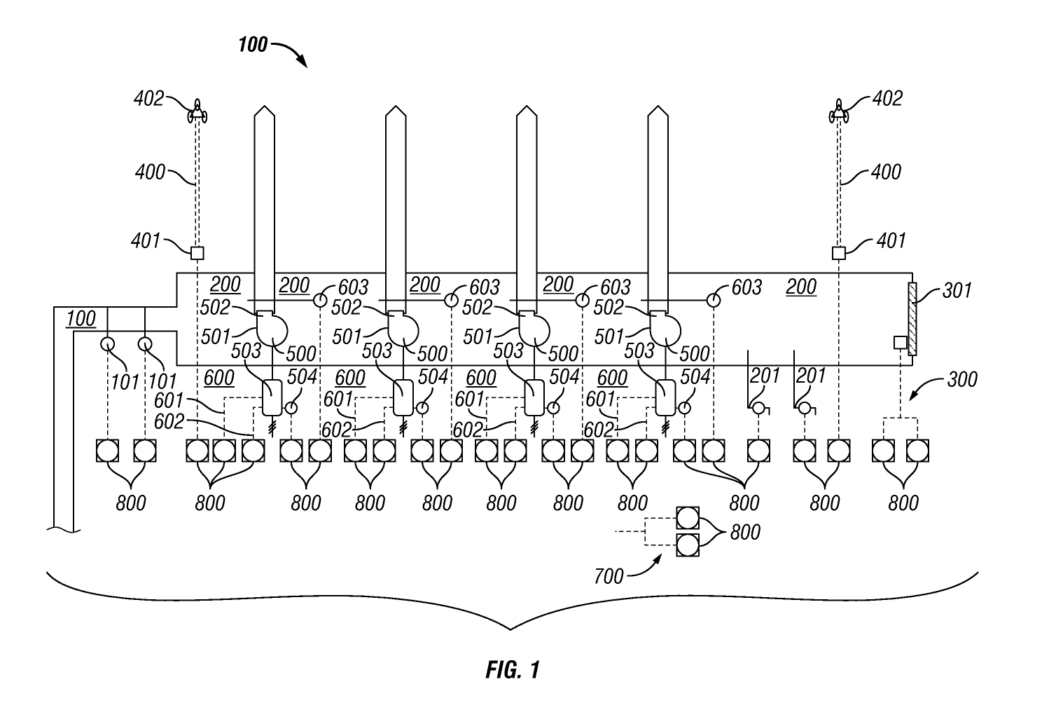

FIG. 1 is a schematic for a preferable exhaust system 1000. As seen in the figure, the exhaust system comprises the following components and sub-systems: the exhaust duct system 100; the cabinet 200; the damper system 300; wind detection system 400; the out-flow fan system 500; the operations system 600; and the decibel/volume detection system 700. The depicted components and sub-systems operate under the command of a direct digital control system 800, as discussed in detail below.

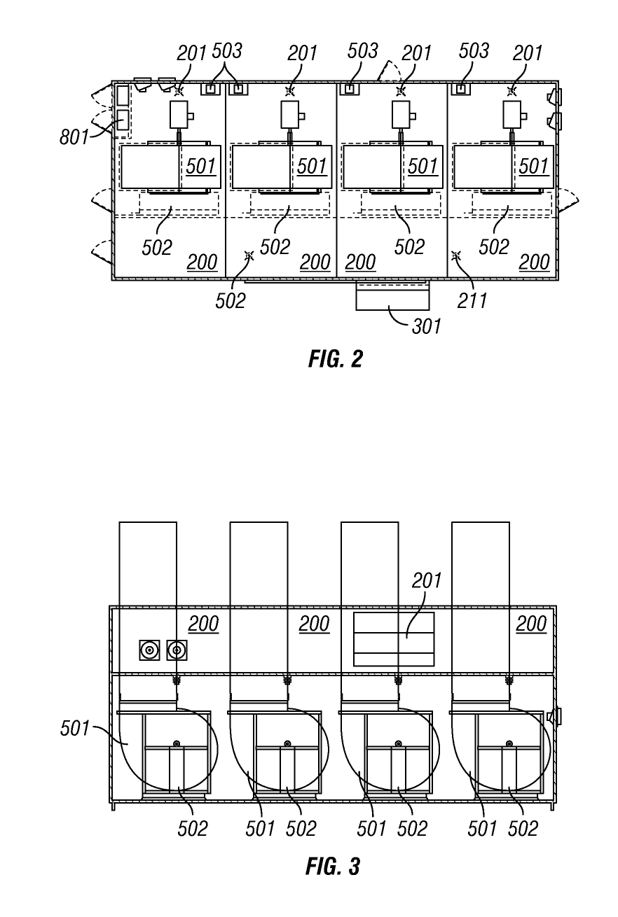

FIGS. 2 and 3 are a plan and side view respectively of a preferable embodiment of the outflow fan system 500, the cabinet 200, and the damper system 300. FIGS. 2 and 3 preferably provide a contextual view of the FIG. 1 schematic.

Still referring again to FIG. 1, the exhaust system 100 preferably defines a means for inputting into the exhaust system 1000. The exhaust duct system 100 suitably comprises a ducting system 102 for connecting laboratory hoods or building exhaust air streams to the exhaust system 1000. In other words, laboratory hood contents and/or other building exhaust air streams are suitably provided to the exhaust air duct system 100 which correspondingly directs the input exhaust air to the exhaust system 1000 for eventual discharge into the environment. As seen in the figure, the exhaust air duct system 100 outlets to the cabinet 200. Also depicted in the figure, but discussed in greater detail below, is a series of flow meters/sensors 101 at the exhaust air system 100 outlet for measuring the flow rate of into the cabinet 200. Measurements from the flow meters/sensors 101 are preferably transmitted to the control system 800.

Yet still referring to FIG. 1, the cabinet 200 preferably defines a chamber for controlled-pressure transmission of exhaust air prior to its dispersion into the ambient environment. The cabinet 200 suitably receives input gases from two gas inlet systems, namely: (1) the exhaust air duct system 100 (mentioned above); and, (2) a damper system 300 (discussed further below). Preferably, the cabinet 200 outlets the input gases via the out-flow fan system 500 (discussed further below). Furthermore, the cabinet 200 comprises a series of pressure sensors 201 for measuring the static pressure within the cabinet 200. The static pressure within the cabinet 200 is controlled and preferably negative whereby the exhaust air within the exhaust air duct system 100 is drawn to the cabinet 200. Measurements from the pressure sensors 201 are preferably transmitted to the control system 800.

Still referring to FIG. 1, the damper system 300 (as mentioned above) defines a means for adjusting the static pressure of the cabinet 200. The damper system comprises at least one outside-air damper 301 that opens to inlet ambient air. As discussed in further detail below, the damper system 300 may supply ambient air to the cabinet 200, particularly during the startup/shutdown of any fan 501 within the fan system 500, thereby controlling the internal static pressure of the cabinet 200. The damper system 300 may also supply ambient air to the cabinet 200 to maintain a maximum (i.e., least negative) level of negative static pressure within the cabinet. Manipulation of the damper system 300 is preferably automatedly accomplished via the control system 800, as discussed below.

Still referring to FIG. 1, the wind detection system 400 defines a means for measuring the wind velocity (i.e., speed and direction). As depicted in the figure, the wind detection system 400 comprises a series of strategically positioned wind speed anemometers 401 and wind vanes 402. Preferably, the wind speed anemometers 401 are for measuring the wind speed and the wind vanes 402 are for measuring the wind direction. Both the anemometers 401 and the vanes 402 are preferably external to the exhaust system 400 and placed at locations in the ambient wind stream 403. Measurements from the anemometers 401 and vanes 402 are preferably transmitted to the control system 800.

Referring to FIG. 1, the out-flow fan system 500 preferably defines a means for regulatedly discharging exhaust air from the cabinet 200 into the ambient environment. Preferably, the out-flow fan system 500 also defines a means for adjusting the static pressure within the cabinet 200, as discussed below, to maintain a minimum (i.e., most negative) level of negative static pressure. As seen in the figure, the out-flow fan system 500 preferably comprises a plurality of fan 501-plus-isolation-damper 502 subsystems. Preferably, the fan 501-plus-isolation-damper 502 subsystems are oriented with the isolation damper 502 upstream from the fan 501. As discussed below, the fans 501 variably operate, as a function of ambient conditions, to discharge the exhaust air from the cabinet 200. Also discussed below, the stated variable operation may entail periods of non-operation (i.e., periods wherein the fan is not discharging air) for one or more fans 501. Since exposing a non-operating fan 501 to the exhaust stream/flow produces a reverse stream/flow through the non-operating fan 501, each isolation damper 502 features a normally-closed configuration that opens depending on whether the associated fan 501 is operating. Conversely, when the associated fan 501 is fully operational, the isolation damper 502 is fully open. Manipulation of the fan 501 plus-isolation-damper 502 subsystems is preferably automatedly accomplished via the control system 800, as discussed below.

Referring now to an individual fan 501-plus-isolation-damper 502 subsystem (as preferably depicted in FIG. 1), the component fan 501 preferably comprises a variable frequency drive 503 for enabling adjustment (as a function of the internal and ambient conditions of the exhaust system 1000) of the associated fan 501 exhaust output levels to between fractional and full emissive capacity. Generally, higher electrical frequencies from the variable frequency drive 503 suitably produce higher fan 501 output flows, and lower frequencies suitably produce lower fan 501 output flows. The electrical frequency supplied by the variable frequency drive 503 to the fan 501 is preferably controlled via the direct digital control system 800, as discussed in detail below.

Still referring to an individual fan 501-plus-isolation-damper 502 subsystem (as preferably depicted in FIG. 1), the component fan 501 further comprises a start/stop mechanism 504 for initiating and/or terminating operation of the associated fan 501. As mentioned above, the fan 501 exhaust output levels are preferably adjusted to between 0% and 100% full emissive capacity. The start/stop mechanism 504 is the means for adjusting the fan to between 0% and fractional capacity. The start/stop mechanism 504 is preferably controlled via the direct digital control system 800, as discussed in detail below.

Preferably, the variable frequency drive 503 features an integral provision for selecting manual or automatic control. Suitably, when manual control is selected, the fan 501 is under full local control regarding its operational speed, however, manual control does not suitably override safety provisions including Fire Alarm shut down. Suitably, if automatic control is selected, then the fan 501 shall be enabled for control by the direct digital control system 800 as discussed below.

Referring again to FIG. 1, the operations system 600 is a means for procuring information necessary to control the variable operation of the exhaust system 1000. As seen in the figure, the operations system 600 preferably comprises the electrical frequency sensor 601, the fan status sensor 602, and the fan flow meter/sensor 603. The frequency sensor 601 preferably identifies the electrical frequency and/or percent of full emissive capacity at which the variable frequency drive 503 is driving the fan 501. The fan status sensor 602 suitably identifies whether the fan 501 is within a period of operation or non-operation. The fan flow meter/sensor 603 preferably measures the fan 501 exhaust flow rate. As discussed below, all three of the subject components communicate the measured or identified information to the direct digital control system 800 for use in dynamically adjusting the operation of the exhaust system 1000.

Referring once again to FIG. 1, the decibel/volume detection system 700 is a means for procuring information regarding outside disturbances or disruptions in conditions that are ambient to the exhaust system 1000. A suitable disturbance or turbulence event is an aircraft approaching the exhaust system 1000 because the associated forces will alter the ambient conditions (especially wind direction and speed) at the exhaust system 1000, but not necessarily at the anemometers 401 and vanes 402 locations, thereby necessitating an adjustment of the exhaust system 1000 to ensure compliance with air-quality regulations. Thus, the decibel/volume detection system comprises at least one decibel/volume sensor 601 for measuring and identifying characteristic decibel/sound levels of approaching aircraft. The identified information is preferably communicated to the direct digital control system 800 for use in dynamically adjusting the operation of the exhaust system 1000.

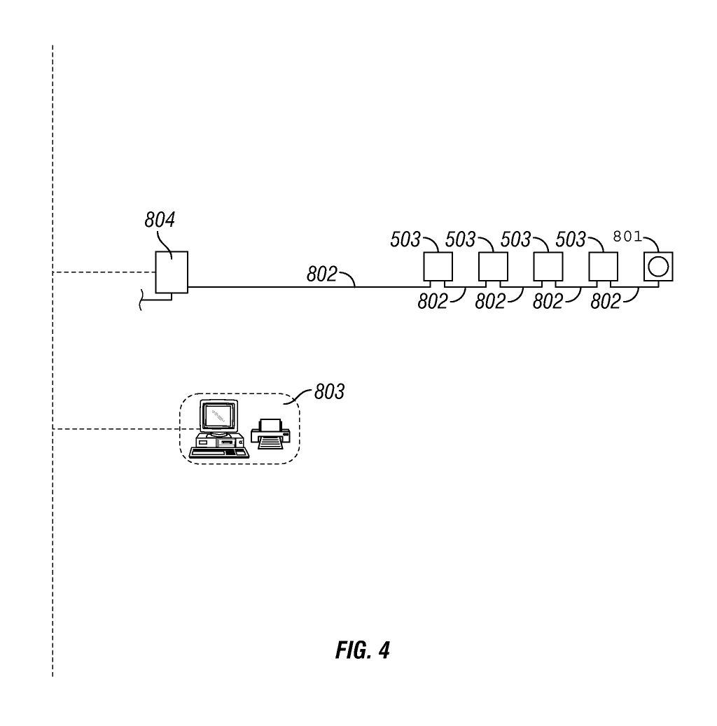

FIG. 4 is a schematic for the direct digital control system 800 architecture. As seen in the figure, the direct digital control system 800 preferably comprises: at least one control station 801 (e.g., a Fx-16 controller that is suitably peer-to-peer redundant) that includes computer software featuring a web-based interface 804 (e.g., JCI TRIDIUM Fx-60 web based interface) plus hardware for receiving data and transmitting commands; a network 802 (e.g., RS-485 Network, BACNET protocol) for communicably linking the exhaust air duct system 100, the cabinet 200, the damper system 300, wind detection system 400, the out-flow fan system 500, the operations system 600, and the decibel/volume detection system 700 to the control station 801; and, a host computer means 803 (e.g., P.C. or lap top computer) for managing the control station 801 off-site via the internet.

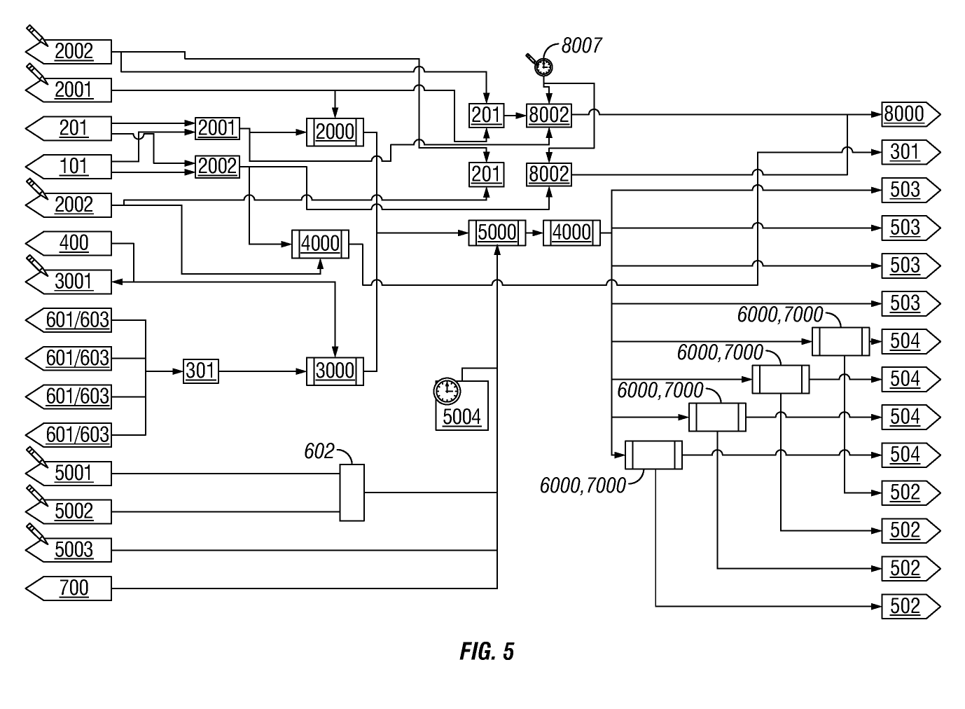

FIG. 5 depicts the exhaust fan logic/sequence. The direct digital control system 800 preferably operates the exhaust system via at least four interrelated control loops: (1) the negative pressure control loop 2000 for controlling the negative pressure within the cabinet 200; (2) the discharge velocity control loop 3000, for controlling the fan 501 out-flow; (3) the damper control loop 4000 for controlling the ambient air inlet on the damper system 300; and, (4) the staging loop 5000 for controlling whether all or some of the output fans 501 are operating.

Referring to FIG. 5 and as mentioned above, the negative pressure control loop 2000 is for maintaining the negative pressure within the cabinet 200. Also as mentioned above, the negative static pressure within the cabinet 200 is the driving force for drawing exhaust air into the cabinet 200 from laboratory hoods or building exhaust air streams. Accordingly, each laboratory or building suitably features: (1) a customized maximum negative pressure 2001 signifying the highest pressure (least negative) within the cabinet 200 sufficient to operate the laboratory hoods or building exhaust air streams; and, (2) a customized minimum negative pressure 2002 signifying the lowest pressure within the cabinet for safe operation of the laboratory hoods or building exhaust air streams. The maximum 2001 and minimum negative pressure values 2002 are preferably customized to each individual exhaust system during Test & Balance.

Suitably, the negative pressure control loop 2000 and outside-air damper control loop 4000 control the static pressure within the cabinet 200 by preferably measuring the static pressure at the pressure sensors 201 and manipulating the operation of the damper system 300 and/or the out-flow fan system 500 accordingly. Regarding the negative pressure control loop 2000: increasing the out-flow fan system 500 discharge reduces the pressure within the cabinet 200; and, decreasing the out-flow fan-system discharge rate increases the pressure within the cabinet 200. Regarding the outside-air damper control loop 4000: increasing the inflow of ambient air via opening the outside-air damper 301 preferably increases the pressure within the cabinet 200; ceasing the inflow of ambient air into the cabinet 200 via closing the outside-air damper 300 results in the pressure level within the cabinet 200 being dependant on the operation of the out-flow fan system 500. Operably, pressure measurements suitably are taken from within the cabinet 200 via the pressure sensors 201 and the information is input into one or more feedback control algorithms that are managed by the direct digital control system 800. According to one algorithm, if the cabinet 200 negative static pressure approaches the maximum threshold, then the direct digital control system 800 suitably commands the variable frequency drive 503 to increase the associated fan 501 emissive output, thereby reducing the cabinet 200 pressure. Relatedly, if the cabinet 200 negative pressure approaches the minimum threshold, then the direct digital control system 800 suitably commands the variable frequency drive 503 to reduce the associated fan 501 emissive outputs to increase the cabinet 200 pressure. According to another algorithm, if reducing fan 501 output would result in non-compliant air-quality and plume heights, then the negative static pressure within the cabinet 200 is increased by opening the outside-air damper 301.

For preferable static pressure control, accurate pressure measurements within the cabinet 200 are desirable. Accordingly, the pressure sensors 201 are suitably positioned for measuring the static pressure of the cabinet 200 at the most remote locations and at the exhaust valves within the cabinet 200 (exact measurement locations are preferably determined during Test & Balance). As mentioned above and depicted in FIG. 5, measurements from the pressure sensors 201 are input to the control algorithm (negative pressure control loop 2000 and the outside-air damper control loop 4000) on the direct digital control system 800 for determining the appropriate operation of the variable frequency drive 503 and the outside-air damper 301.

Still referring to FIG. 5, since the negative static pressure within the cabinet 200 is controlled for optimal operation of the laboratory hoods or building exhaust air streams, the preferable embodiment of the present exhaust system 1000 also preferably features a feed-forward control algorithm based on measurements taken from the exhaust air system 100 at the flow meters/sensors 101. Conceptually, the flow rate of exhaust air within the exhaust air duct system 100 is dependent on the negative static pressure within the cabinet 200: the lower the negative static pressure, the greater the flow rate; and, the higher the negative static pressure, the lower the flow rate. Accordingly, a feed forward control algorithm incorporating the flow meter/sensor 101 readings may suitably be the installed on the direct digital control system 800 for feed-forwardly deriving variable frequency drive 503 and outside-air damper 301 commands. Use of such a feed-forward control algorithm, in conjunction with the control algorithm stated above, preferably increases the control over the static pressure within the cabinet 200.

Still referring to FIG. 5, the discharge velocity control loop 3000 is suitable for controlling the fan 501 out-flow whereby the exhaust system 1000 discharges at sufficient rates for compliance with air-quality and plume height requirements. Compliance is controlled by measuring wind speed and wind direction at the wind detection system 400 and adjusting the out-flow fan system 500 discharge rates accordingly.

Regarding the discharge velocity control loop 3000, dispersion modeling may be used to facilitate the derivation of the feedback/feed-forward control algorithm. Dispersion modeling is the engineering technique used to determine exhaust system output gas flow rates (as a function of ambient conditions) for compliance with air-quality regulations and restrictions. Because exhaust flow rates for air-quality compliance will be specifically dependant on the ambient conditions of the associated exhaust system 1000, the dispersion model is preferably developed using a combination of full-scale field study, reduced scale wind-tunnel study, and/or a mathematical modeling study of the system's ambience. In other words, data specific to the particular exhaust system 1000 environment and mathematics may be used to determine the relationship between the system's 1000 exhaust flow rates, and the air-quality in the vicinity of the exhaust system 1000 (e.g., air intakes, operable windows, and pedestrian areas). For example, dispersion modeling for a constant diameter exhaust air discharge stack results in the following relationship:

$$Mo = {( \frac{Ve}{Uc} )}^{2} λ ;$$

wherein Mo is the system specific ratio of exhaust momentum to wind momentum that provides a sufficient plume height for dispersing the exhaust air whereby the air-quality concentrations are met; wherein Ve is the exhaust air escape velocity from the discharge stack; wherein Uc is the ambient wind speed; and wherein λ is the variable correction factor for the differing wind directions. Exact methods for determining the system 1000 specific relationship between the exhaust flow rates and air-quality will be readily apparent to those skilled in the art.

Generally, dispersion modeling indicates that as wind speed increases, the discharge rate must also increase to comply with air-quality and plume height requirements, however, at extremely high winds, the inherent dispersive effect of the high winds may accomplish sufficient exhaust air dispersion. Generally, as wind direction points toward air intakes, operable windows, pedestrian areas, and etcetera, the exhaust system 1000 discharge rate must increase to comply with air-quality and plume height requirements at the stated locations. Accordingly, wind speed and direction measurements collected from the anemometer system 400 are preferably input into one or more feedback/feed-forward control algorithms that are managed by the direct digital control system 800. Fan 501 output flow rates are measured via the flow meter 603 and fan capacity is measured via the electrical frequency sensor 601 and the information is input into the associated feedback control algorithm on the direct digital control system 800.

According to one algorithm, as the wind speed varies, the direct digital control system 800 suitably commands the variable frequency drive 503 to vary the electric frequency provided to the associated fan 501. Relatedly, if the wind direction changes then the direct digital control system 800 suitably commands the variable frequency drive 503 to vary the electric frequency provided to the associated fan 501. According to another algorithm, if the fan 501 output flow rate is not sufficient for compliance with air-quality and plume heights, then the direct digital control system 800 suitably commands the variable frequency drive 503 to increase the electric frequency provided to the associated fan 501.

Still referring to FIG. 5, the staging loop 5000 for controlling whether all or some of the output fans 501 are operating. As mentioned above, output fans 501 preferably operate at zero to fractional capacity in non-emergency situations. The control algorithm for the staging loop 5000 preferably accounts for efficient exhaust system 1000 operation, the building/laboratory occupation schedule, and external disturbances.

Still referring to the staging loop 5000 depicted in FIG. 5, the control algorithm accounts for the efficient operation of the exhaust system 1000. In the preferable embodiment, each fan 501 features an optimal range of operational fractional emissive capacity (e.g., 20% to 90% of full capacity) for more efficient use of energy. Suitably, the optimal range is provided to the direct digital control system 800 in the form of a maximum percent 5001 of full fan 501 emissive capacity 5001 and a minimum percent 5002 of full fan 501 emissive capacity 5002. According to the subject control algorithm, if the fan electrical frequency sensor 601 indicates a fractional operating capacity above the maximum percent of full fan capacity 5001 then a fan 501 start-up sequence 6000 is initiated whereby non-operating fans 501 may be turned on to contribute to the discharge and decrease the percent of full capacity for the fans 501 in continued operation. Relatedly, if the fan electrical frequency sensor 601 indicates a fractional emissive capacity below the minimum percent 5001 of full fan 501 capacity, then a fan 501 shut-down sequence 7000 is initiated whereby fans 501 are preferably turned off to increase the percent of full capacity for the fans 501 in continued operation.

Still referring to the staging loop 5000 depicted in FIG. 5, the control algorithm accounts for the building/lab occupation schedule 5003. In the typical building, the occupation schedule dictates a variation in the default number of operating fans 501 for air-quality and plume height compliance. In other words, fewer fans 501 may preferably operate at higher percentages of full capacity during time periods wherein a building or laboratory is unoccupied because the conditions necessitating higher fan output are less likely to result. Accordingly, a control algorithm will compare the building occupation schedule 503 with the system 1000 time and calendaring information 504. According to the algorithm, if the building/laboratory is within a scheduled occupied time period, then additional fans 501 will by default start and run at lower percentages of full capacity; and, if the building/laboratory is within an unoccupied time period, excess fans 501 will shut-down and the fans 501 in continued operation will operate at higher percentages of full emissive capacity. The exact number of fans 501 preferable for the default number of fans 501 for occupied and unoccupied exhaust system 1000 operation can be determined during Test & Balance, but can vary.

Still referring the staging loop 5000 depicted in FIG. 5, the control algorithm accounts for the probable external disturbances of the exhaust system 1000. As mentioned above, external disturbances (e.g., aircraft) may result in the exhaust system's 1000 non-compliance with air-quality and plume height requirements. Accordingly, the system features the decibel/volume detection system 700 as a means for procuring information regarding outside disturbances or disruptions in conditions that are ambient to the exhaust system 1000. The information is provided to the staging loop 5000 whereafter, the associated control algorithm adjusts the discharge of the exhaust output fans 501 so the associated disturbance is overcome to ensure air-quality compliance. In one embodiment, the algorithm suitably operates all output fans 501 at full capacity until the external disturbance dissipates.

FIG. 5 also illustrates a preferable start up 6000 and shut-down 7000 sequences for each fan. The start-up sequence 6000 is preferably as follows: the start/stop mechanism 504 of the fan 501 is activated; the isolation damper 502 preferably remains closed until the fan 501 is operational (as evidenced by the status sensor 602); and, the isolation damper 502 is opened to the subject fan 501 operating at a fraction of full capacity as commanded by the direct digital control system 800 (determined by the discharge velocity control loop 3000). The shut down sequence 6000 is preferably as follows: the isolation damper is closed and the start/stop mechanism 504 is activated. Preferably, each fan features a bypass damper whereby the fan 501 can start-up or shut down while the isolation damper 504 is closed.

Derivation of the appropriate feed-forward and feedback control algorithms depends on the geometry and specifications of an individual system and those skilled in the art of process control will know well the methods and steps for deriving such control algorithms. Subject thereto, the logic of the control algorithms can be obtained in the above description and the associated drawings.

FIG. 5 also depicts an optional feature of the exhaust system 1000: the static pressure alarm 8000. Suitably, if the exhaust system 1000 static pressure within the cabinet 200 falls below the minimum 2001 or exceeds maximum 2002 set point value for a period in excess of the tolerable control delay (i.e., the adjustable alarm delay period) 8001, a static pressure alarm 8000 shall be initiated. The preferable exhaust system features a timer for measuring the actual delay period 8002, and the alarm algorithm compares the actual delay 8002 versus the tolerable control delay 8001.

FIG. 5 also depicts another optional feature of the exhaust system: the fan rotation control 9000. To equalize fan 501 use, the direct digital control system 800 preferably logs the hours of accumulated run time for each exhaust fan 501. At an adjustable change-over time period (i.e., every 40 hours), the fan with the highest amount of accumulated runtime hours shall be placed last in the starting sequence of the available fans 501. The fan 501 with the least amount of accumulated runtime hours shall preferably be set as the lead fan (first fan) in the fan 501 starting sequence 6000. Conversely, the fan 501 with the greatest amount of accumulated runtime hours shall preferably be set as the first fan the shut-down sequence 7000. Each individual fan's 501 runtime hours may be manually reset from an operator's terminal 803 on the direct digital control system 800.

Other optional features include a fan 501 failure alarm which may preferably be triggered via contradictory indications on the: (1) start/stop mechanism 504 and the status sensor 602; or, the electrical frequency sensor 601 and the fan discharge flow meter/sensor 603.

It should be noted that a building may require multiple systems 1000, but one direct digital control 800 might preferably be used to control the multiple exhaust systems 1000.

It should also be noted that conventional exhaust systems may be retrofitted with the systems and methods of the present invention. Retrofitting is preferably and generally accomplished by: assessing the operable range of static pressure within said cabinet; performing a dispersion modeling exercise to determine an operable exhaust rate, as a function of conditions ambient to the cabinet, for compliance with air-quality standards; locating a pressure sensor within said cabinet for recurrently measuring the static pressure therein; locating at least one anemometer external to said cabinet for recurrently measuring the wind speed ambient to said cabinet; locating at least one vane external to said cabinet for recurrently measuring the wind direction ambient to said cabinet; deriving at least one algorithm for varying the emissive capacity of any one of said plurality of fans based on said recurrent measurements of either of said pressure sensor, said anemometer, or said vane; and, coupling a controller to said fan and said sensors, said controller for implementing said algorithm. Other components and algorithms can be derived for the retrofitted exhaust system in a similar manner as described above in connection with the FIGS. 1 through 4.

In summary, what is disclosed might be a method of emitting exhaust air comprising the steps of: providing exhaust air to an exhaust system featuring at least one fan; recurrently measuring at least one internal condition within the exhaust system; recurrently measuring at least one condition ambient to said exhaust system; and recurrently varying the emissive capacity of said fan according to changes in the said measurements.

It should be noted that FIGS. 1 through 4 and the associated descriptions are of illustrative importance only. In other words, the depictions and descriptions of the present invention should not be construed as limiting of the subject matter in this application. The apparatuses, assemblies, components, order and inclusion of steps, and methods discussed hereby are susceptible to modification without changing the overall concept of the disclosed invention. Such modifications might become apparent to one skilled in the art after reading this disclosure.

Further disclosed are the following:
1. An exhaust system comprising:
   at least one cabinet;
   at least one pressure sensor disposed within said cabinet for recurrently measuring the static pressure therein;
   at least one wind speed anemometer for recurrently measuring the ambient wind speed;
   at least one wind vane for recurrently measuring the ambient wind direction;
   a plurality of exhaust fans operably coupled to said cabinet;
   an algorithm for varying the emissive capacity of at least one of said fans based on said recurrent measurements from said pressure sensor;
   an algorithm for varying the emissive capacity of at least one of said fans based on said recurrent measurements from said anemometer and said vane; and,
   a controller for automatedly implementing said algorithms.
2. The exhaust system of claim 1 further comprising:
   a decibel sensor for recurrently measuring the ambient decibel level;
   an algorithm for varying the emissive capacity of at least one of said fans based on said recurrent decibel measurements.
3. The exhaust system of claim 2 further comprising:
   a calendaring system for scheduling expectant periods of greater or lesser exhaust system use; and,
   an algorithm for varying the emissive capacity of at least one of said fans based on said scheduling of expectant periods of greater or lesser exhaust system use.
4. The exhaust system of claim 3 wherein said fan features a range of energy efficient emissive capacities and said exhaust system further comprising:
   a sensor for recurrently measuring the emissive capacity of each fan within said plurality of fans;
   an algorithm for shutting down one of said fans based on said measurement of emissive capacity being below said efficient range; and,
   an algorithm for starting one of said fans based on said measurement of emissive capacity being above said efficient range.
5. The exhaust system of claim 4 further comprising:
   an isolation damper per fan within said plurality of fans;
   a sensor for measuring the status of at least one of said fans;
   an algorithm for opening said isolation damper while the associated fan is operational, and for closing said isolation damper while the associated fan is operational.
6. The exhaust system of claim 5 further comprising:
   an outside air damper;
   an algorithm for opening or closing said outside air damper based on said measurements of said static pressure sensor.
7. The exhaust system of claim 6 further comprising:
   an alarm system;
   a timer for measuring the length of the time period wherein said measurements of said cabinet pressure are outside of said range;
   a predetermined time length;
   an algorithm for sounding said alarm when said measured time length exceeds said predetermined time length.
8. The exhaust system of claim 6 further comprising:
   a timer for measuring a gross operating time of each of said fans within said plurality of said fans;
   an algorithm for adjusting the emissive capacity of said fans based on said measurement of said gross operating time.
9. A method of emitting from a cabinet comprising the steps of:
   assessing the operable range of static pressure within the cabinet;
   performing a dispersion modeling exercise to determine an operable exhaust rate, as a function of conditions ambient to the cabinet, for compliance with air-quality standards;
   providing at least one exhaust fan to said cabinet;
   recurrently measuring the actual static pressure of said cabinet;
   recurrently measuring at least one actual condition ambient to said cabinet;
   recurrently varying the emissive capacity of said fan according to changes in the said actual static pressure and actual ambient condition measurements, whereby said static pressure is controlled to within the said operable range, and whereby the fan accomplishes emission at said operable exhaust rate.
10. The method of claim 9 further comprising the steps of:
   assessing a range of energy efficient emissive capacities for said fan;
   recurrently measuring the operating emissive capacity for said fan;
   starting another of said fans if said measurement of said operating emissive capacity is above said range.
11. The method of claim 10 further comprising the step of
   Shutting down one of said fans if said measurement of said operating emissive capacity is below said range.
12. The method of claim 9 further comprising the steps of:
   recurrently measuring the ambient decibel level;
   recurrently varying the emissive capacity of said fan according to changes in the said ambient decibel level.
13. The method of claim 10 further comprising the step of isolating said fan that is started from said cabinet.
14. The method claim 11 further comprising the step of isolating said fan that is shut down from said cabinet.
15. A method of retrofitting a preinstalled environmental exhaust systems featuring a cabinet and a plurality of exhaust fans comprising the steps of:
   assessing the operable range of static pressure within said cabinet;
   performing a dispersion modeling exercise to determine an operable exhaust rate, as a function of conditions ambient to the cabinet, for compliance with air-quality standards;
   locating a pressure sensor within said cabinet for recurrently measuring the static pressure therein;
   locating at least one anemometer external to said cabinet for recurrently measuring the wind speed ambient to said cabinet;
   locating at least one vane external to said cabinet for recurrently measuring the wind direction ambient to said cabinet;
   deriving at least one algorithm for varying the emissive capacity of any one of said plurality of fans based on said recurrent measurements of either of said pressure sensor, said anemometer, or said vane; and,
   coupling a controller to said fan and said sensors, said controller for implementing said algorithm.
16. The method of claim 15 further comprising the steps of:
   assessing a range of energy efficient emissive capacities for said fan;
   locating a sensor for recurrently measuring the emissive capacity of said fan;
   deriving an algorithm for shutting down one of said fans when said measurements of said emissive capacity fall below said range; and,
   coupling said sensor to said controller.
17. The method of claim 16 further comprising the step of deriving an algorithm for starting one of said fans when said measurement of said emissive capacity is rises above said range.
18. The method of claim 15 further comprising the steps of:
   Locating a decibel sensor for recurrently measuring the ambient decibel level;
   deriving an algorithm for recurrently varying the emissive capacity of said fan according to changes in the said ambient decibel level; and,
   coupling said decibel sensor to said controller.
19. The method of claim 17 further comprising the steps of:
   locating an isolating damper upstream said fan;
   locating a sensor for recurrently measuring the status of said fan;
   deriving an algorithm for opening said isolation damper based on the said measurement of fan status; and,
   coupling the isolation damper and said status sensor to the controller.
20. A method of emitting exhaust air comprising the steps of:
   Providing exhaust air to an exhaust system featuring at least one fan;
   recurrently measuring at least one internal condition within exhaust system;
   recurrently measuring at least one condition external to said exhaust system; and,
   recurrently varying the emissive capacity of said fan according to changes in the said measurements.
21. An exhaust system operationally configured to evacuate exhaust air from a building comprising:
   at least one exhaust fan;
   a pathway from vents inside said building to said exhaust fan;
   at least one exhaust vent disposed on top of said building; and,
   a regulating means for selectively controlling the rate of dispersion of said exhaust air from said building.

We claim:

1. An exhaust system comprising:
at least one cabinet;
at least one pressure sensor disposed within said cabinet for recurrently measuring the static pressure therein;
at least one wind speed anemometer for recurrently measuring the ambient wind speed;
at least one wind vane for recurrently measuring the ambient wind direction;
a plurality of exhaust fans operably coupled to said cabinet;
an algorithm for varying the emissive capacity of at least one of said fans based on said recurrent measurements from said pressure sensor;
an algorithm for varying the emissive capacity of at least one of said fans based on said recurrent measurements from said anemometer and said vane; and,
a controller for automatedly implementing said algorithms.

2. The exhaust system of claim 1 further comprising:
a decibel sensor for recurrently measuring the ambient decibel level;
an algorithm for varying the emissive capacity of at least one of said fans based on said recurrent decibel measurements.

3. The exhaust system of claim 2 further comprising:
a calendaring system for scheduling expectant periods of greater or lesser exhaust system use; and,
an algorithm for varying the emissive capacity of at least one of said fans based on said scheduling of expectant periods of greater or lesser exhaust system use.

4. The exhaust system of claim 3 wherein said fan features a range of energy efficient emissive capacities and said exhaust system further comprising:
a sensor for recurrently measuring the emissive capacity of each fan within said plurality of fans;
an algorithm for shutting down one of said fans based on said measurement of emissive capacity being below said efficient range; and,
an algorithm for starting one of said fans based on said measurement of emissive capacity being above said efficient range.

5. The exhaust system of claim 4 further comprising:
an isolation damper per fan within said plurality of fans;
a sensor for measuring the status of at least one of said fans;
an algorithm for opening said isolation damper while the associated fan is operational, and for closing said isolation damper while the associated fan is operational.

6. The exhaust system of claim 5 further comprising:
an outside air damper;
an algorithm for opening or closing said outside air damper based on said measurements of said static pressure sensor.

7. The exhaust system of claim 6 further comprising:
an alarm system;
a timer for measuring the length of the time period wherein said measurements of said cabinet pressure are outside of said range;
a predetermined time length;
an algorithm for sounding said alarm when said measured time length exceeds said predetermined time length.

8. The exhaust system of claim 6 further comprising:
a timer for measuring a gross operating time of each of said fans within said plurality of said fans;
an algorithm for adjusting the emissive capacity of said fans based on said measurement of said gross operating time.

9. A method of emitting from a cabinet comprising the steps of:
assessing the operable range of static pressure within the cabinet;
performing a dispersion modeling exercise to determine an operable exhaust rate, as a function of conditions ambient to the cabinet, for compliance with air-quality standards;
providing at least one exhaust fan to said cabinet;
recurrently measuring the actual static pressure of said cabinet;
recurrently measuring at least one actual condition ambient to said cabinet;
recurrently varying the emissive capacity of said fan according to changes in the said actual static pressure and actual ambient condition measurements, whereby said static pressure is controlled to within the said operable range, and whereby the fan accomplishes emission at said operable exhaust rate.

10. The method of claim 9 further comprising the steps of:
assessing a range of energy efficient emissive capacities for said fan;
recurrently measuring the operating emissive capacity for said fan;
starting another of said fans if said measurement of said operating emissive capacity is above said range.

11. The method of claim 10 further comprising the step of
Shutting down one of said fans if said measurement of said operating emissive capacity is below said range.

12. The method of claim 9 further comprising the steps of:
recurrently measuring the ambient decibel level;
recurrently varying the emissive capacity of said fan according to changes in the said ambient decibel level.

13. The method of claim 10 further comprising the step of isolating said fan that is started from said cabinet.

14. The method claim 11 further comprising the step of isolating said fan that is shut down from said cabinet.

15. A method of retrofitting a preinstalled environmental exhaust systems featuring a cabinet and a plurality of exhaust fans comprising the steps of:
assessing the operable range of static pressure within said cabinet;
performing a dispersion modeling exercise to determine an operable exhaust rate, as a function of conditions ambient to the cabinet, for compliance with air-quality standards;
locating a pressure sensor within said cabinet for recurrently measuring the static pressure therein;
locating at least one anemometer external to said cabinet for recurrently measuring the wind speed ambient to said cabinet;
locating at least one vane external to said cabinet for recurrently measuring the wind direction ambient to said cabinet;
deriving at least one algorithm for varying the emissive capacity of any one of said plurality of fans based on said recurrent measurements of either of said pressure sensor, said anemometer, or said vane; and,
coupling a controller to said fan and said sensors, said controller for implementing said algorithm.

16. The method of claim 15 further comprising the steps of:
assessing a range of energy efficient emissive capacities for said fan;
locating a sensor for recurrently measuring the emissive capacity of said fan;
deriving an algorithm for shutting down one of said fans when said measurements of said emissive capacity fall below said range; and,
coupling said sensor to said controller.

17. The method of claim 16 further comprising the step of deriving an algorithm for starting one of said fans when said measurement of said emissive capacity is rises above said range.

18. The method of claim 15 further comprising the steps of:
Locating a decibel sensor for recurrently measuring the ambient decibel level;
deriving an algorithm for recurrently varying the emissive capacity of said fan according to changes in the said ambient decibel level; and,
coupling said decibel sensor to said controller.

19. The method of claim 17 further comprising the steps of:
locating an isolating damper upstream said fan;
locating a sensor for recurrently measuring the status of said fan;
deriving an algorithm for opening said isolation damper based on the said measurement of fan status; and,
coupling the isolation damper and said status sensor to the controller.

20. A method of emitting exhaust air comprising the steps of:
Providing exhaust air to an exhaust system featuring at least one fan;
recurrently measuring at least one internal condition within exhaust system;
recurrently measuring at least one condition external to said exhaust system; and,
recurrently varying the emissive capacity of said fan according to changes in the said measurements.

21. An exhaust system operationally configured to evacuate exhaust air from a building comprising:
at least one exhaust fan;
a pathway from vents inside said building to said exhaust fan;
at least one exhaust vent disposed on top of said building; and,
a regulating means for selectively controlling the rate of dispersion of said exhaust air from said building.
